(19) United States
(12) Patent Application Publication
(10) Pub. No.: US 2012/0073513 A1
(43) Pub. Date: Mar. 29, 2012

(54) SHAGGY PET TOY AND METHOD OF CONSTRUCTION

(75) Inventor: THOMAS MCCANN, Weston, CT (US)

(73) Assignee: INNOVATIVE DESIGN & SOURCING, LLC, MILFORD, CT (US)

(21) Appl. No.: 12/890,305

(22) Filed: Sep. 24, 2010

(51) Int. Cl. A01K 29/00; B29C 65/48

(52) U.S. Cl. 119/707; 156/245

(57) ABSTRACT

A toy for a pet and method for fabricating a toy for a pet having a shaggy thick fleece fabric outer coating and an inner body of an elastically deformable rubber core with the rubber hollow core body molded from at least two rubber core sections to form a rubber seam between the sections, and with the sheep fleece covering formed by adhesively attaching the pieces of thick fleece fabric to the rubber core body with each piece of fabric being of an appropriate size and in a thickness of between about 8 mm to 20 mm and having cut edges for forming the outline of a predetermine pattern corresponding to the desired shape for the pet toy and in an arrangement with the cut edges abetting each other on the rubber core surface so that the entire peripheral surface of the rubber core body is covered and with one or more fabric seams being formed which lie along the mated edges in a pattern having an orientation independent of the orientation of the rubber seams.

### FIELD OF THE INVENTION

This invention relates to an animal toy having a thick fleece outer covering and method of construction.

### BACKGROUND ART

Toys for pet animals which require mobility and bounce during play typically possess an inner elastically deformable rubber core. This provides the toy with an appropriate degree of firmness and rigidity necessary to give the toy mobility and bounce during play. An outer coating of a felt or other mated fabric material is typically formed on all toys in which a rubber core is used as the body of the toy. In contrast, stuffed toys, i.e., toys stuffed with e.g., a polyurethane fill or toys with a vinyl body provide very little, if any, mobility and bounce and, in general, are covered with a thick fleece fabric of woven or knit construction to form a pile or napped fabric covering having a thick heavy surface resembling sheep's wool. The thick fleece represents a shaggy surface which is soft to the touch and has a texture and feel which enhances the attractiveness of the stuffed toy and is known to be safe for use with an animal. It is, however, not known to utilize a thick fleece fabric to form a shaggy surface coating on a toy for a pet having an inner elastically deformable rubber core since a rubber core is intended for mobility and bounce and a thick fleece fabric is known to impair mobility and bounce and is therefore counterintuitive to use with a rubber core body.

It has been discovered in accordance with the present invention that a pet toy can be constructed with a shaggy thick fleece fabric outer coating and an inner elastically deformable rubber core body to provide sufficient mobility and bounce for use by a pet, even a spherical toy ball, provided the fleece outer fabric is limited to a thickness range between 8 and 20 mm and optimally about 12 mm. In this thickness range it has been discovered that the toy will retain a controlled bounce which is minimally erratic and suitable for a pet with the shaggy thick fleece outer surface providing a soft surface which many pets find desirable and which is safe for use by the pet.

### SUMMARY OF THE INVENTION

The method of the present invention for fabricating a toy having a shaggy thick fleece fabric outer coating and an inner body of an elastically deformable rubber core comprises the steps of molding a rubber hollow core body from preferably two rubber core half sections each of semi-spherical geometry to form a molded hollow body having a rubber seam between the half sections, adhesively attaching one or more pieces of thick fleece fabric to the rubber core body with each piece of fabric being of an appropriate size with a thickness of between about 8 mm to 20 mm and having cut edges for forming the outline of a predetermine pattern, aligning the edges of the one or more pieces of fabric on the rubber core surface so that the entire peripheral surface of the rubber core body is covered with such fabric with the edges abetting each other, and molding the rubber core and fabric covering at a sufficient pressure and temperature to form fabric seams at the abetting edges with the abetting edges disposed in a pattern having an orientation independent of the position of the rubber seams.

A pet toy product is fabricated in accordance with the present invention comprising; an inner body of an elastically deformable rubber core of any desired geometrical shape, a plurality of pieces of shaggy thick fleece fabric each substantially equal in size and of a thickness in a range of between about 8 mm to 20 mm with each being adhesively attached to the outer surface of the rubber core body in an arrangement covering the entire outer surface of the rubber core and in abetting relationship to one another to form fabric seams between the pieces and having an orientation such that the arranged pieces form a desired toy pattern, based upon the geometrical shape of the rubber core, selected from the group comprising: a spherical ball, a football, a bone, a dumbbell, a donut shaped ring, a heart and a star. The elastically deformable rubber core in the pet toy product may incorporate a squeaker of any conventional construction which may be mounted into a hole formed in the body of the rubber core after the rubber core is molded and may be covered by the shaggy thick fleece fabric.

### BRIEF DESCRIPTION OF DRAWINGS

FIG. 1 is a diagrammatic illustration of the method of the present invention for fabricating a pet toy tennis ball with the method consisting of five steps represented by FIGS. 1(a), 1(b), 2(a), 2(b), 3, 4 and 5, respectively, in which:

FIG. 1(a) is illustrative of Step 1 of the method and is a front view of a hollow semi-spherical half section of a rubber core having a diameter conforming to the diameter of a typical tennis ball;

FIG. 1(b) is a cross sectional view of the half section of rubber core of FIG. 1 (a) taken along the lines 1-1;

FIG. 2(a) is illustrative of Step 2 of the method and is a front view in elevation of a hollow rubber core composed of two half semi-spherical sections molded together and forming a rubber seam between the two half sections with the seam line aligned in parallel to the vertical axis of the paper;

FIG. 2(b) is a cross sectional view of the hollow rubber core of FIG. 2(a);

FIG. 3 is illustrative of Step 3 of the method and is a side view of a single piece of sheep fleece in a cut pattern corresponding to a desired shape for forming a toy tennis ball in accordance with the method of the present invention;

FIG. 4 is illustrative of Step 4 of the method and is a front view in elevation showing the rubber core of FIG. 1 covered with two pieces of sheep fleece cut in the pattern of FIG. 3, with one of the pieces shown lifted off the surface to indicate how the pieces are adhesively applied for forming fabric seam lines between the two pieces;

FIG. 5 is an exploded view of a mold for molding a toy tennis ball from the shaggy sheep fleece covered rubber core of FIG. 4;

FIG. 6(a) is a front view of a piece of shaggy sheep fleece fabric in a patterned cut shape for covering a rubber core in the fabrication of a pet toy having a donut shaped ring configuration;

FIG. 6(b) is view in elevation of a donut shaped rubber core covered with two cut pieces of shaggy fleece fabric each having the pattern of FIG. 6(a) with one end of a piece of fabric shown lifted off the surface of the rubber core to indicate how it is adhesively applied to form a fabric seam between the pieces of shaggy fleece fabric;

FIG. 6(c) is a view similar to FIG. 6(a) showing a set of two complimentary pieces of shaggy fleece fabric each in a patterned cut shape for fabricating a donut shaped ring configuration using four pieces of shaggy fleece fabric;

FIG. 6(d) is a view in elevation of a donut shaped rubber core covered with four cut pieces of shaggy fleece fabric using two sets of shaggy fleece fabric shown in FIGS. 6(c);

FIG. 7(a) is a front view in elevation of one piece of a shaggy sheep fleece fabric in a patterned cut shape for covering a rubber core in the fabrication of a pet toy having a bone shaped configuration;

FIG. 7(b) is view in elevation of a bone shaped rubber core body covered with two cut pieces of shaggy fleece fabric each having the pattern of FIG. 7(a) with one end of a piece of fabric shown lifted off the surface of the rubber core body to indicate how it is being adhesively applied to form a fabric seam between the two pieces of shaggy fleece in the fabrication of a pet toy in a bone shape;

FIG. 7(c) is a view similar to FIG. 7(a) showing three pieces of shaggy sheep fleece fabric in a patterned cut shape for covering a rubber core from the three pieces of shaggy sheep fleece fabric for fabricating a pet toy having a bone shaped configuration;

FIG. 7(d) is a view in elevation of a bone shaped rubber core covered with the three pieces of shaggy fleece fabric shown in FIG. 7(c);

FIG. 8(a) is a front view of one piece of shaggy sheep fleece fabric cut to a pattern for fabricating a dumbbell shaped toy in accordance with the method of the present invention;

FIG. 8(b) is view in elevation of a dumbbell shaped toy having a rubber core with a shaggy thick fleece fabric covering formed by using two pieces of shaggy thick fleece fabric with each conforming to the size and pattern of FIG. 8(a) and adhesively applying each to the surface of the rubber core so that the edges mate with one of the pieces shown lifted off the surface of the rubber core;

FIG. 8(c) is a view similar to FIG. 8(a) showing three pieces of shaggy sheep fleece fabric in a patterned cut shape for covering a rubber core having a dumbbell shaped configuration from the three pieces of shaggy sheep fleece fabric;

FIG. 8(d) is a view in elevation of a dumbbell shaped rubber core covered with the three cut pieces of shaggy fleece fabric shown in FIG. 8(c);

FIG. 9(a) is a front view of one of four cut pieces of shaggy sheep fleece fabric each having the same size and pattern as indicated for fabricating a football shaped toy in accordance with the method of the present invention;

FIG. 9(b) is a view in elevation of a football shaped toy having a rubber core and with the four pieces of shaggy thick fleece fabric of FIG. 9(a) adhesively applied to the surface of the rubber core and with one end of each of the four pieces shown lifted off the surface of the inner rubber core at the same end thereof to illustrate how each piece is adhesively applied to form fabric seam lines between the four pieces in the pattern of a football;

FIG. 10(a) is a front view of one of two cut pieces of shaggy sheep fleece fabric each having the same size and pattern as indicated for fabricating a star shaped toy in accordance with the method of the present invention;

FIG. 10(b) is a view in elevation of a star shaped toy having a rubber core with two pieces of shaggy thick fleece fabric in the pattern of FIG. 10(a) adhesively applied to the surface of the rubber core and with one end of one of the two pieces shown lifted off the surface of the inner rubber core to illustrate how the pieces form a fabric seam between the two pieces of fabric;

FIG. 10(c) is a view showing the patterned cut shape of two of three pieces of shaggy sheep fleece fabric for fabricating a pet toy having a star shaped configuration with the third piece representing a duplicate of the cut star shaped piece of fleece fabric shown in FIG. 10(c);

FIG. 10(d) is a view in elevation of a star shaped rubber core covered with three pieces of shaggy fleece fabric using the patterned cut pieces shown in FIG. 10(c);

FIG. 11(a) is a view showing the patterned cut shape of two of three pieces of shaggy sheep fleece fabric for fabricating a pet toy having a heart shaped configuration with the third piece representing a duplicate of the cut heart shaped piece of fleece fabric shown in this figure;

FIG. 11(b) is a view in elevation of a heart shaped rubber core covered with three pieces of shaggy fleece fabric using the patterned cut pieces of fabric shown in FIGS. 11(b);

FIG. 12(a) is an exploded view showing in cross section the molded rubber core body of FIG. 1 with a hole drilled therein for insertion of a squeaker also shown in cross section; and

FIG. 12(b) is an exploded view of the rubber core and squeaker of FIG. 12(a) shown in perspective.

### DETAILED DESCRIPTION OF THE INVENTION

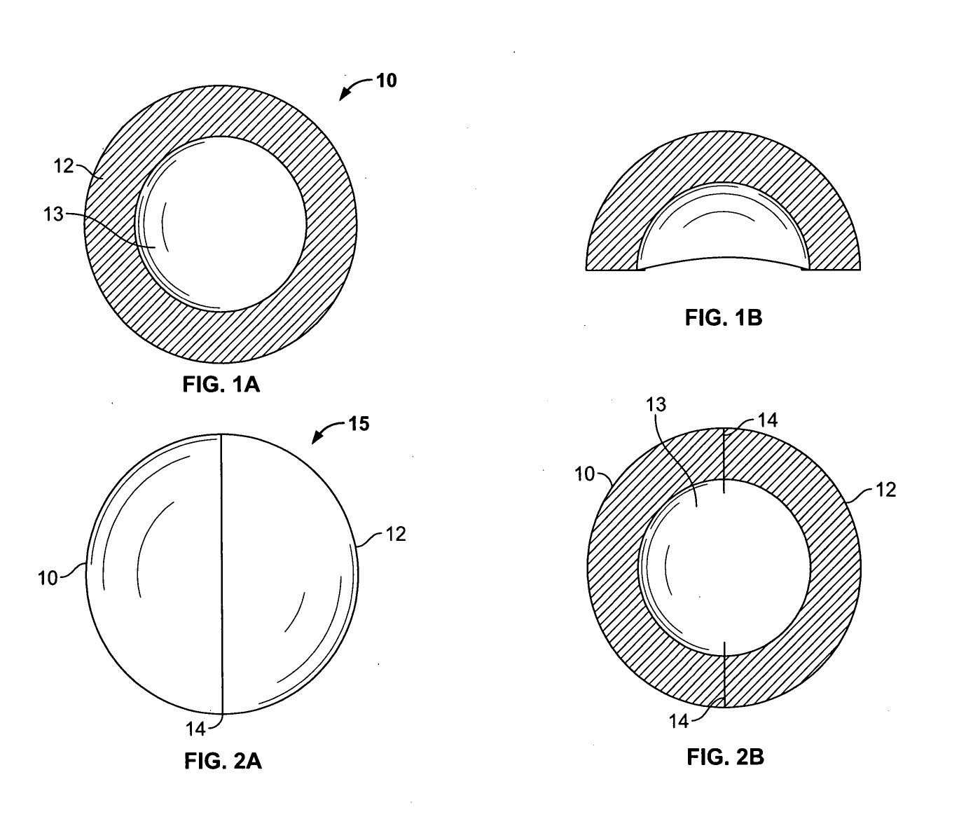

The invention will first be described in connection with the preferred embodiment of fabricating a toy tennis ball for a pet having a rubber inner core and an outer covering of sheep fleece. This embodiment is illustrated in FIGS. 1-5 inclusive, and requires five steps. FIG. 1(a) is a front view of a hollow semi-spherical half section 10 of the rubber core body 15 shown in FIG. 2(a) having a diameter and size conforming to the diameter and size of a typical tennis ball. The half section 10 has an annular flat area 12 defining an edge surrounding a hollow core center 13. Step one involves molding two such semi-spherical half sections 10 and 11 into the single rubber core body 15 by applying a conventional composition of glue to the flat annular area 12 around each half section 10 and 11 and pressing the flat areas together to form a rubber seam 14 between the half sections 10 and 11. The adhesive at the seam line 14 is cured into a rubber seam by a conventional molding operation under the application of pressure and heat.

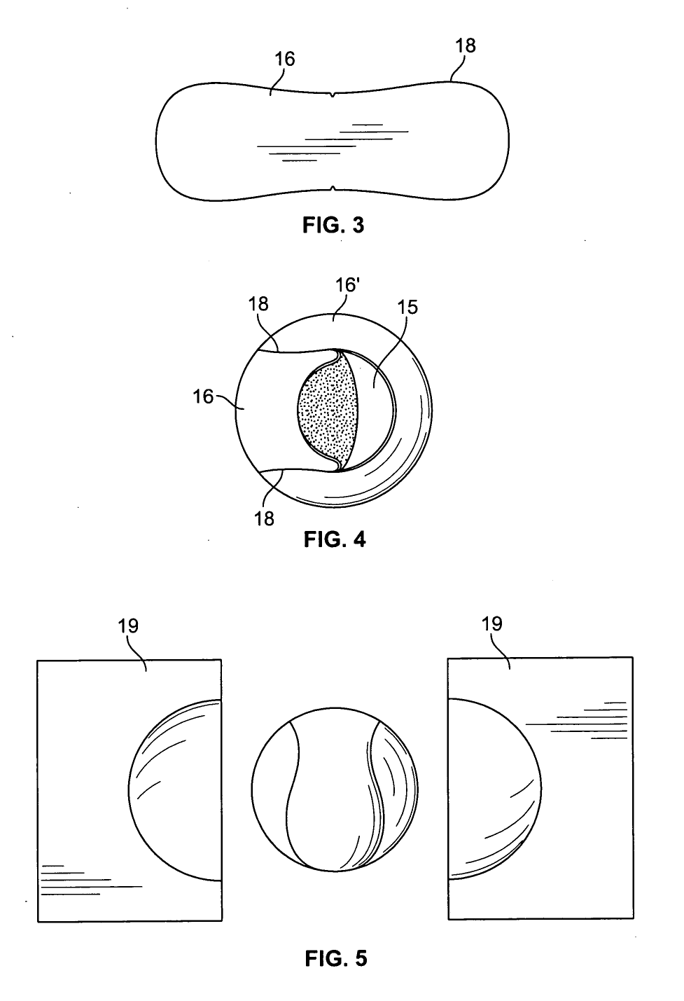

FIG. 3 is a side view of a single piece of sheep fleece 16 in a cut pattern corresponding to a desired shape for forming a toy tennis ball covering for the ball shaped hollow rubber core body 15 in accordance with the method of the present invention. The single piece 16 has cut edges 18 which form fabric seams in the cover surrounding the tennis ball in accordance with the method of the present invention. FIG. 4 is a front view in elevation showing how two pieces of sheep fleece 16 and 16′, each being of a similar size and shape corresponding to the pattern of FIG. 3, are applied to the surface of the molded rubber core body 15 preferably after applying glue over the entire surface of the rubber core body 15. Each piece 16 and 16′ of sheep fleece fabric is applied in succession to the periphery of the rubber core body 15 so that one piece 16 is adhesively attached to the rubber core body 15 before applying a second piece 16′. The cut edge 18 at the periphery of the first piece is aligned with the cut edge 18 of the second piece so that the pieces mate along the edges 18 with the two pieces 16 and 16′ covering the entire surface of the rubber core body 15. The mated edge 18 forms a fabric seam during molding upon the application of pressure and heat. Any conventional glue composition may be used which will cause each piece of sheep fleece 16 and 16′ to adhere to the rubber core body 15 and cure during molding. In FIG. 4 one of the pieces of sheep fleece 16 is shown lifted off the surface of the rubber core body 15 to indicate how the two pieces are aligned to form mated edges 18 between the two pieces.

The molded rubber core 15 and the adhesively attached cover which includes the two sheep fleece pieces 16 and 16′ is placed in a mold 19 as shown in FIG. 5 to cure the adhesive along the mated edge 18 between the pieces of fabric 16 and 16′ for forming a fabric seam. The fabric seam formed along the edge 18 may be oriented to form any desired pattern with such orientation being completely independent of the orientation of the rubber seam 14 formed between the half sections of rubber core 15.

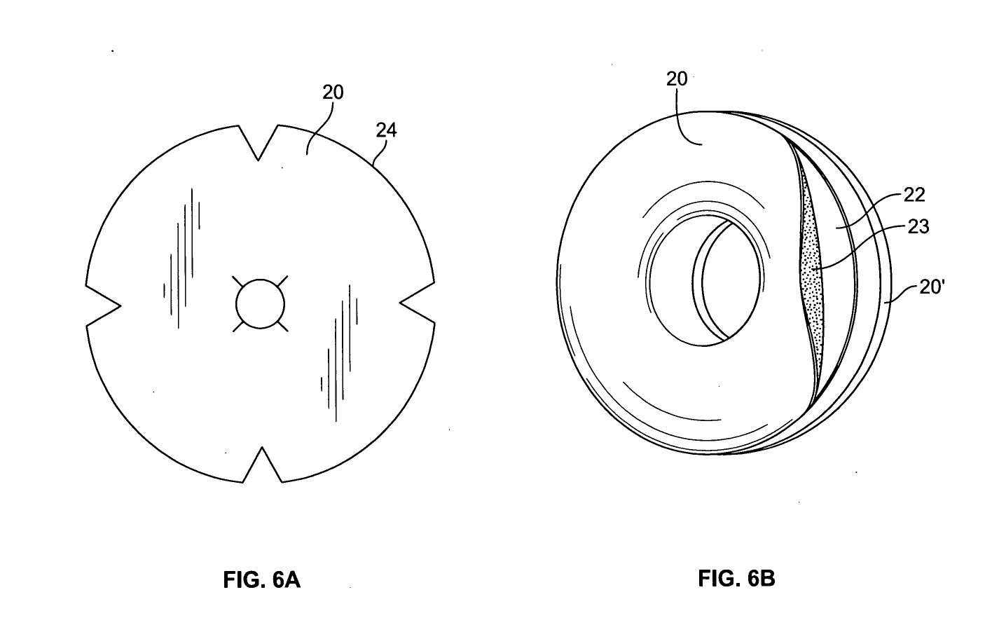

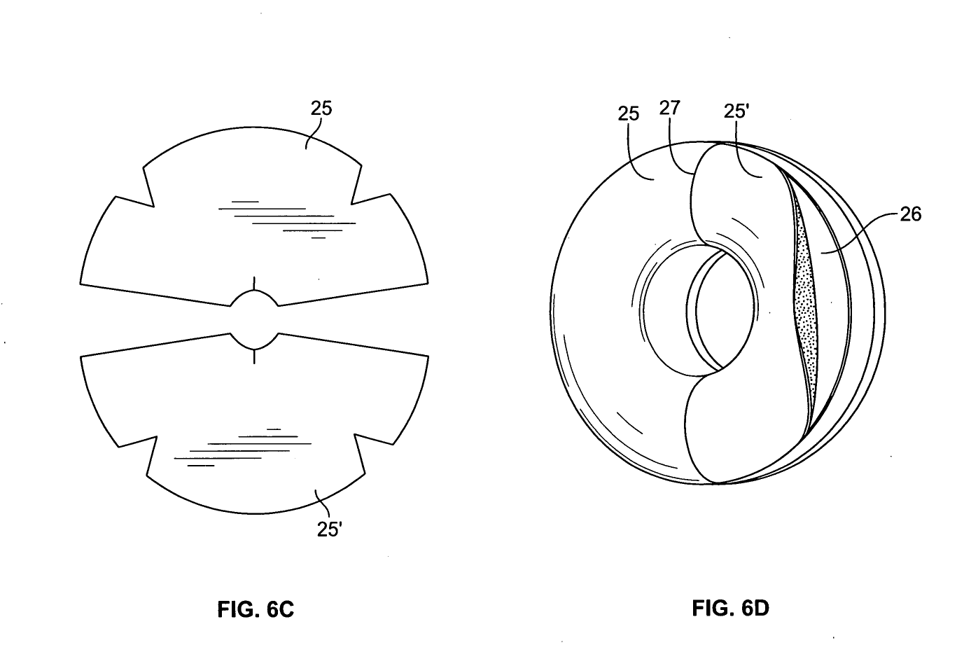

An alternative embodiment is shown in FIG. 6 for fabricating a pet toy having a donut shaped ring configuration. FIG. 6(a) is a front view of a piece 20 of shaggy sheep fleece fabric in a patterned cut shape for forming a covering for a rubber core body in the shape of a donut. FIG. 6(b) is view in elevation of a donut shaped rubber core body 22 covered with two cut pieces of shaggy fleece fabric 20 and 20′ on each side of the rubber core body 22 with each piece of fabric having a size and shape conforming to the piece of cut fabric 20 shown in FIG. 6(a). One end 23 of the piece of fabric 20 is shown lifted off the surface of the rubber core body 22 to indicate how it is adhesively applied to the surface of the rubber core body 22 with its edges 24 of each of the pieces of fabric being in abutting alignment. The rubber core body 22 and covered fabric is placed in a mold (not shown) to fasten the pieces 20 and 20′ to the rubber core body 22 and to cure the adhesive at the edges 24 into a fabric seam.

Alternatively, the donut shaped ring configuration may be formed in accordance with the present invention using for example, four pieces of shaggy sheep fleece instead of two pieces. FIG. 6(c) shows a set of two complimentary pieces of shaggy fleece fabric 25 and 25′ with each piece cut in a patterned shape for fabricating a donut shaped ring configuration having multiple pieces of shaggy fleece fabric. The two complimentary pieces of shaggy fleece fabric 25 and 25′ are applied successively to one side of a rubber core body 26, e.g., the top side, after a conventional glue composition has been applied the surface of the rubber core body 26. Each of the two pieces of fabric 25 and 25′ have an identical cut edge 24 which are placed into abutting alignment on the top side of the rubber core body 26 to form a fabric seam 27 on the top side of the rubber core body 26 between the two pieces of shaggy fleece fabric 25 and 25′ as shown in FIG. 6(d). Similarly, a second set of two pieces of shaggy fleece fabric(not shown), which are duplicates of the first set 25 and 25′ shown in FIG. 6(c), are adhesively attached to the opposite or underside of the rubber core body 26 to form another fabric seam duplicating the fabric seam 27 but on the opposite or underside surface of the rubber core body 26 resulting in the rubber core body 26 being covered with four pieces of shaggy fleece fabric having two duplicate fabric seams 27 formed on each opposite side of the rubber core body 26 when placed in a mold at an elevated temperature and pressure.

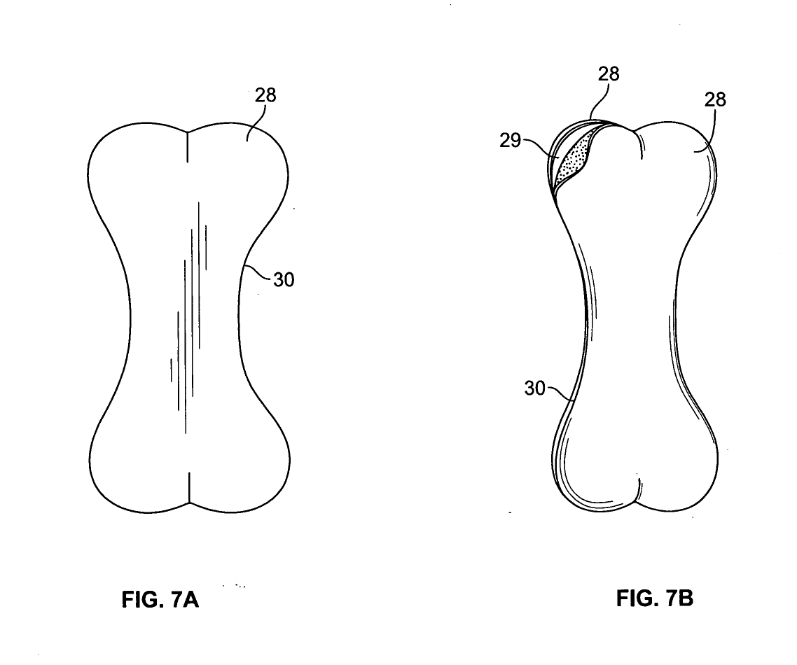

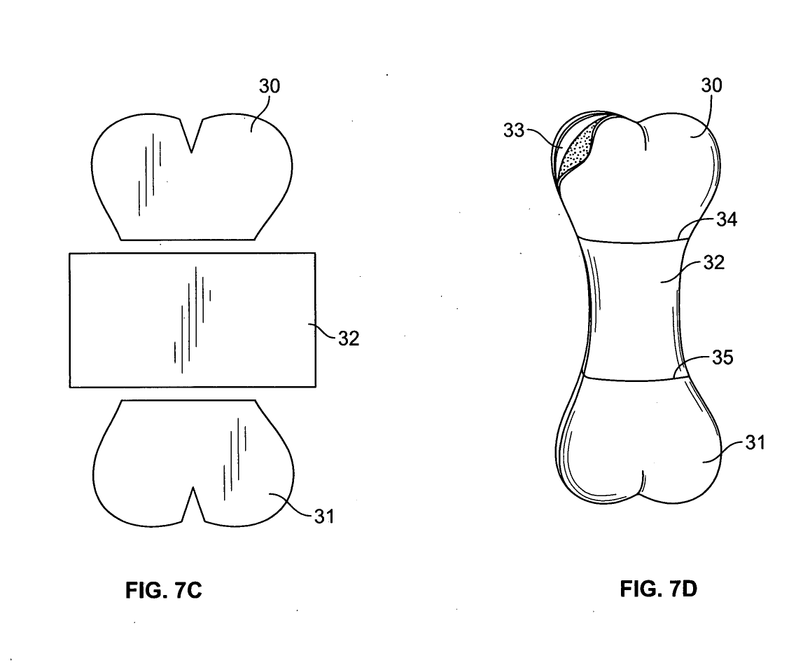

Another embodiment of the invention is shown in FIGS. 7(a) and 7(b) for fabricating a pet toy in a bone shape with FIG. 7(a) representing a front view of one piece 28 of shaggy sheep fleece fabric in a patterned cut shape for covering a rubber core body 29 shaped as a bone in the fabrication of a pet toy having a bone shape geometry. FIG. 7(b) shows a bone-shaped rubber core body 29 covered with two cut pieces of shaggy fleece fabric 28 and 28′ on each opposite side thereof with each piece of fabric having the same size and pattern shape of the one piece of fabric 28 shown in FIG. 7(a). One end of the piece of fabric 28 is shown in FIG. 7(b) lifted off the surface of the rubber core body 29 to indicate how it is adhesively attached to the core body 29 to form a fabric seam 30 between the two pieces of shaggy fleece fabric in the fabrication of a bone shaped pet toy. The pieces of fabric 28 and 28′ are aligned with the edge 30 in abutting relationship relative to one another on the surface of the rubber core body 29 so that a fabric seam is formed at the mated edge 30 between the two pieces of fabric during molding.

Alternatively, a pet toy with a bone shaped configuration may be formed using, for example, three pieces of shaggy fleece fabric instead of two. FIG. 7(c) shows three pieces of shaggy sheep fleece fabric 30, 31 and 32 in a patterned cut shape with the two pieces 30 and 31 intended for covering opposite ends of a rubber core body 33 as shown in FIG. 7(d). The third piece 32 functions as a center section interconnecting the other two pieces 30 and 31 for fabricating a bone shaped configuration from the three pieces of shaggy sheep fleece fabric. The three pieces are adhesively applied in succession to the rubber core body 33 as shown in FIG. 7(d) so that the two pieces 30 and 31 adhesively cover opposite ends of the rubber core body 33. The piece 32 is adhesively applied to the rubber core body 33 between the pieces 30 and 31 as an intermediate section for forming two fabric seams 34 and 35 upon placing the bone-shaped body 33 with the three piece covering of shaggy sheep fleece in a mold and applying pressure and heat. The fabric seams 34 and 35 lie substantially in parallel alignment between the center section 32 and each piece of fabric 30 and 31 respectively.

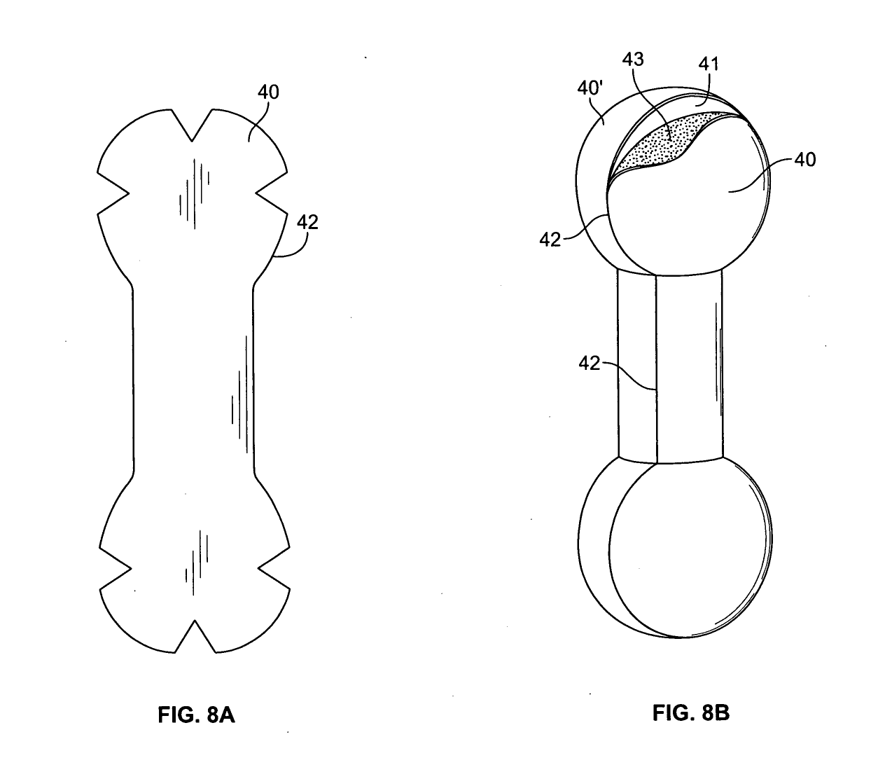

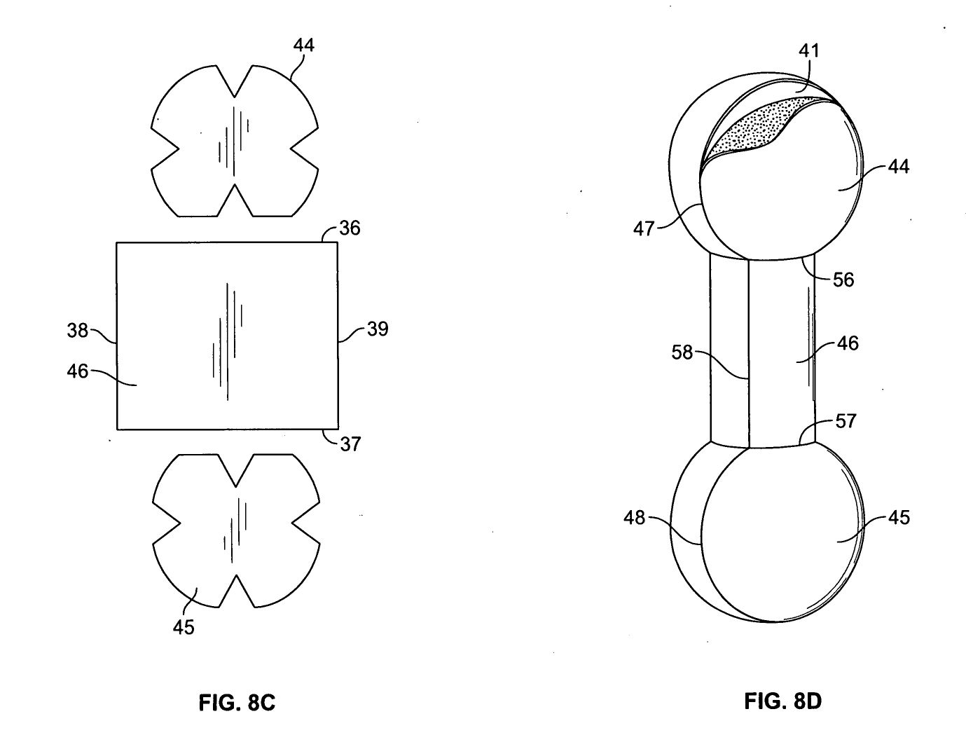

A further embodiment of the present invention is shown in FIGS. 8(a) and 8(b) for fabricating a pet toy in a dumbbell shape. FIG. 8(a) represents a front view of one piece 40 of shaggy sheep fleece fabric cut to a pattern for fabricating a dumbbell shaped toy in accordance with the method of the present invention. FIG. 8(b) is view in elevation of a dumbbell shaped toy having a rubber core body 41 in a dumbbell shape covered with two pieces of shaggy thick fleece fabric 40 and 40′ with each piece of fabric conforming to the size and pattern of the piece 40 of FIG. 8(a). Each piece of fabric is adhesively applied to the surface of the rubber core body 41 so that the edge 42 of each piece is in mated abutment relative to each other on the rubber core body 41 to form a fabric seam 42 at the mated edges during molding at elevated pressure and temperature. In FIG. 8(b) one end 43 of the piece of fabric 40 is shown lifted off the surface of the rubber core body 41 to illustrate how the pieces of fabric 40 and 40′ are adhesively applied to the rubber core body 41.

Alternatively, a pet toy in a dumbbell shaped configuration may be formed having a covering with three or more pieces of shaggy thick fleece fabric. FIG. 8(c) shows three pieces of shaggy sheep fleece fabric 44, 45 and 46 in a patterned cut shape for covering a rubber core body 41 for fabricating a pet toy in a dumbbell shaped configuration using the three pieces of shaggy sheep fleece fabric 44, 45 and 46 of FIG. 8(a). The two pieces 44 and 45 are cut into an identical shape and size for covering the opposite ends of the rubber core body 41 as shown in FIG. 8(d) with the piece 46 forming a center section interconnecting the two pieces of fabric 44 and 45 at opposite ends of the rubber core body 41. After covering the rubber core body 41 with a conventional glue composition, each piece of fabric 44 and 45 is adhesively attached in succession to cover the opposite ends of the rubber core body 41 to form fabric seams 47 and 48 at each opposite end of the rubber core body 41. The piece 46 is adhesively attached over the rubber core body 41 between each piece of fabric 44 and 45 so that the opposite ends 36 and 37 of the center piece 46 abut the edges of each of the pieces 44 and 45 to form fabric seams 56 and 57 and with the ends 38 and 39 of the center piece 46 abutting one another when the center piece 46 is covered over the rubber core body 41 to form a fabric seam 58. The fabric seams 47, 48, 56, 57 and 59 are formed when the dumbbell shaped toy is molded under the application of pressure and heat.

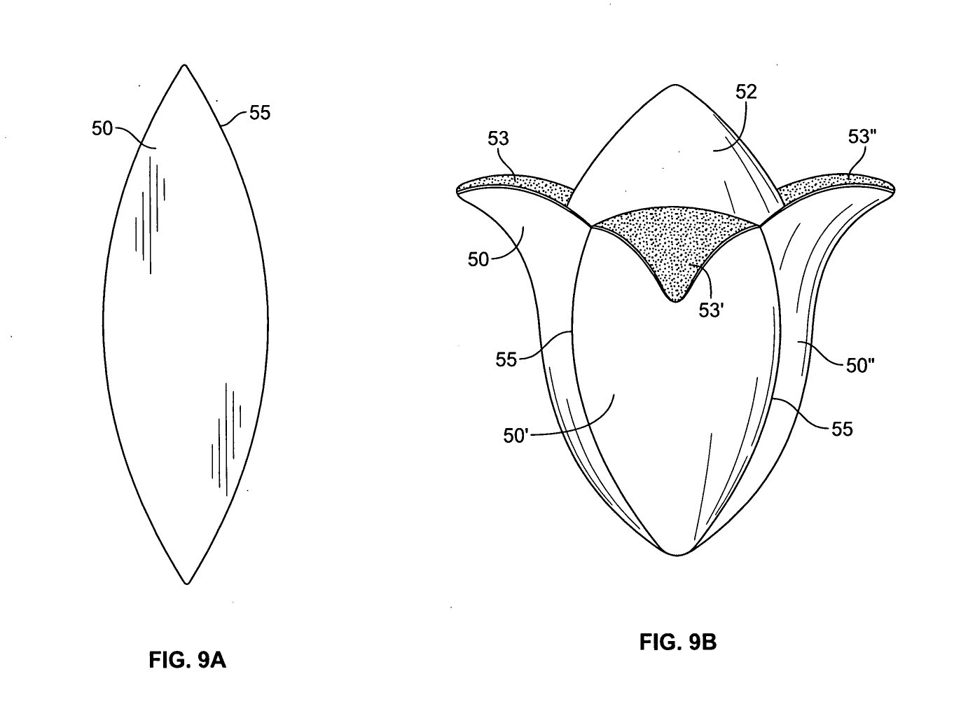

Yet another embodiment of the present invention is shown in FIGS. 9(a) and (9b) for fabricating a pet toy in the shape of a football with FIG. 9(a) representing a front view of one piece 50 of shaggy sheep fleece fabric for fabricating a football shaped toy in accordance with the method of the present invention. FIG. 9(b) is a view in elevation of a football shaped toy rubber core 52 covered with four pieces of shaggy thick fleece fabric 50, 50′, 50″ and 50′″, with only three of the pieces 50, 50′ and 50″ being visible in FIG. 9(b). Each of the four pieces of fabric are of substantially identical size and shape and conforms to the cut pattern of the piece 50 in FIG. 9(a), and are successively applied to the surface of the rubber core body 42 as shown in FIG. 9(b) after glue is applied to the surface for attaching each piece to the core body 52 so that the entire surface of the rubber core body 42 is covered with the edge 55 of each piece of fabric 50, 50′, 50″ and 50′″ in mated alignment with the corresponding edge 55 of each adjacent piece of fabric to form fabric seams at each of the mated edges 55 when the rubber core body 52 with the covered four pieces of fabric is placed in a mold (not shown) under pressure and temperature. In FIG. 9(b), one end 53, 53′ and 53″ of each of the four pieces is shown lifted off the surface of the inner rubber core body 52 at the same end thereof, except for the end 53′″ which is not visible, to illustrate how each piece of fabric is adhesively attached to form a fabric seam at the edge 55 between the four pieces of fabric.

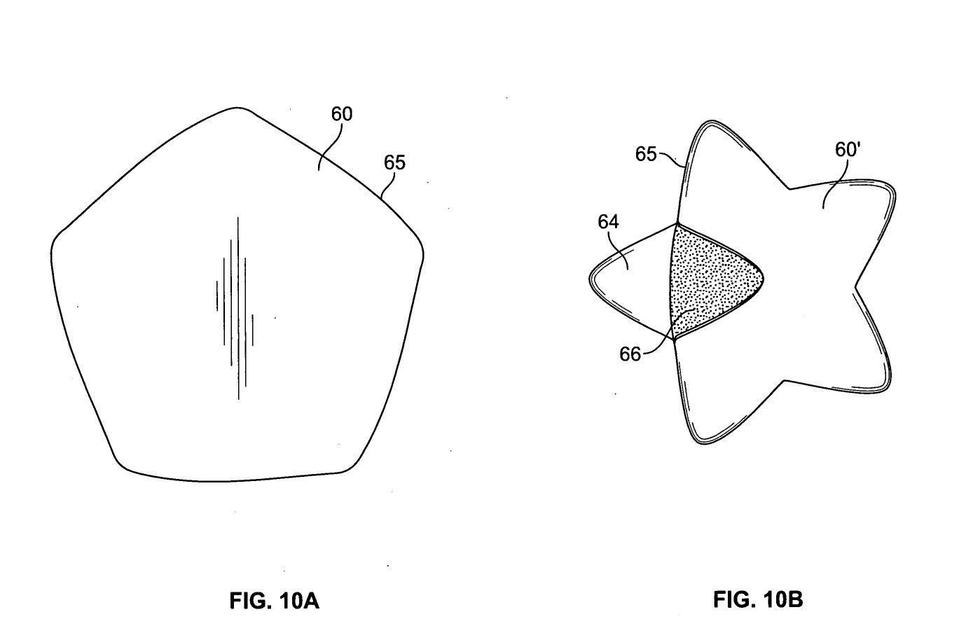

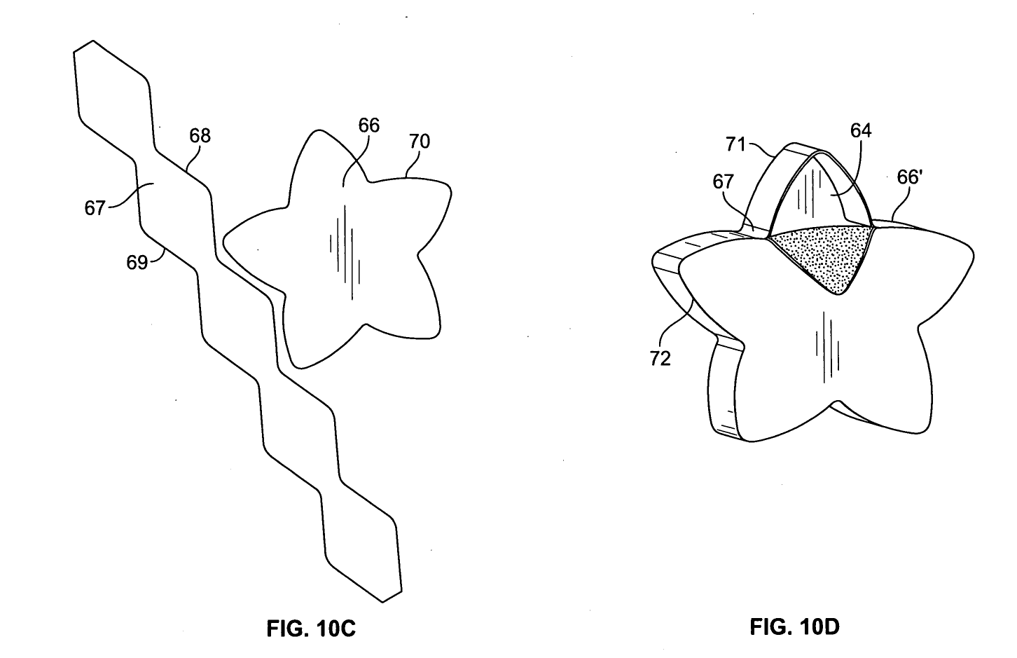

An even further embodiment of the present invention is shown in FIGS. 10(a) and 10(b) for fabricating a pet toy in the shape of a star, with FIG. 10(a) representing a front view of one of two cut pieces of shaggy sheep fleece fabric 60 and 60′, each having the same size and pattern as indicated in FIG. 10(a) for fabricating a star-shaped toy, in accordance with the method of the present invention. Each piece of fabric 60 and 60′ is adhesively applied to opposite side surfaces of a star-shaped rubber core body 64 so that the edge 65 of each piece 60 and 60′ is mated in abutted alignment with each other to form a fabric seam along the mated edge 65 during molding, upon the application of temperature and pressure. FIG. 10(b) is a view in elevation of a star-shaped toy formed with a rubber core body 64 in the shape of a star and with the two pieces of shaggy thick fleece fabric 60 and 60′ in the pattern of FIG. 10(a) being adhesively applied to opposite surfaces of the rubber core body 64. The piece of fabric 60 on the opposite side of the rubber core body 64 is not visible in FIG. 10(b). One end 66 of the piece of fabric 60′ is shown lifted off the surface of the inner rubber core body 64 to illustrate how the pieces 60 and 60′ form a fabric seam at the mated edge 65 between the two pieces of fabric during molding of the pieces of fleece fabric 60 and 60′ to the rubber core body 64.

Alternatively, a pet toy in a star shaped configuration may be formed from three pieces of shaggy thick fleece fabric using two pieces of shaggy fleece fabric 66 and 67 cut in the patterned shape shown in FIG. 10(c). The piece of fabric 66 is cut into the shape of a star and the piece of fabric 67 is cut to form a narrow elongated strip of fabric having undulating edges 68 and 69 in a configuration having a plurality of repeated “V” shaped sections in opposing relationship. Another piece of fabric 66′ which conforms in size and shape to the star shaped piece of fabric 66 shown of FIG. 10(c) is formed to fabricate the star shaped configuration about a rubber core body 64 which itself is star shaped. Each duplicate piece of fabric 66 and 66′ is adhesively applied to opposite sides of the star shaped rubber core body 64 as shown in FIG. 10(d) with the piece of fabric 66 on the non-visible side of the rubber core body 64. The piece of fabric 67 is adhesively attached between the pieces of fabric 66 and 66′ around the body of the star shaped rubber core 64 such that the edge 68 of the piece of fabric 67 is mated to the edge of the star shaped fabric piece 66 to form a fabric seam 71 and the edge 69 is mated to abut a complimentary edge of the star shaped fabric piece 66′ to form a fabric seam 72 as shown in FIG. 10(d) after molding at elevated temperature and pressure. The three pieces of fabric 66, 67 and 66′ form a cover surrounding the core body in a sandwich arrangement with the piece of fabric 67 interconnecting the fabric pieces 66 and 66′ on opposite side of the rubber core body 64. Each of the three pieces 66, 66′ and 67 are adhesively attached to the star shaped rubber core body 64 in succession in order to align the edges 68 and 69 to the edge of the fabric pieces 66 and 66′. FIG. 10(d) is a view in elevation of the star shaped toy formed with the three pieces of shaggy thick fleece fabric 66, 66′ and 67.

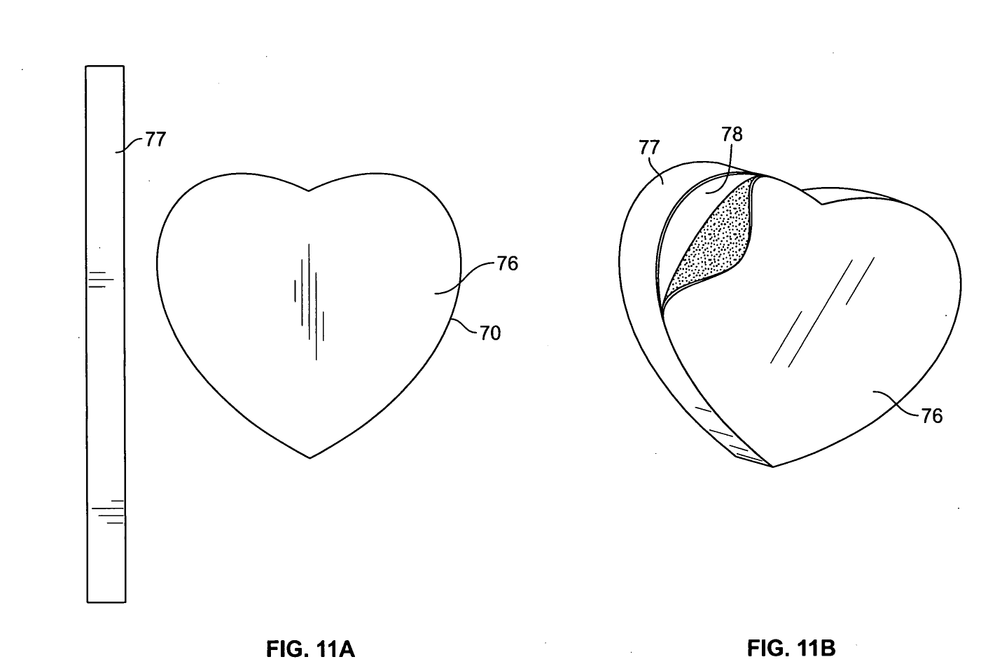

As shown in FIGS. 11(a) and 11(b) a pet toy can be fabricated having a heart shape instead of a star shape using either two or three pieces of shaggy fleece fabric in a manner equivalent to the teaching for fabricating a stat shape as shown in FIGS. 10(a) to 10(d) respectively. When fabricating a heart shape toy using three pieces of shaggy fleece fabric, two of the pieces 76 and 77 should be cut in the pattern as shown in FIG. 11(a). A duplicate heart shaped piece 76′ is used as the third piece to form a heart shaped shaggy fleece fabric covering over a rubber core body 78 as shown in FIG. 11(b) with the fabric piece 76 on the non-visible side of the rubber core body 78.

It is significant to note that for each embodiment of the invention fabric seam lines are being formed during molding without the presence of any exposed rubber seams, regardless of toy shape. Accordingly, a pet will only touch soft fabric during play which enhances the safety of the toy.

In all of the embodiments of the present invention, each of the pieces of shaggy sheep fleece fabric should have of a thickness in a range of between 8 mm to 20 mm thick in order to create the softness needed to minimize erratic bouncing. Moreover, the treads of the sheep fleece fabric should be of the same length to provide a uniform consistent thickness in a range of between 8 mm to 20 mm.

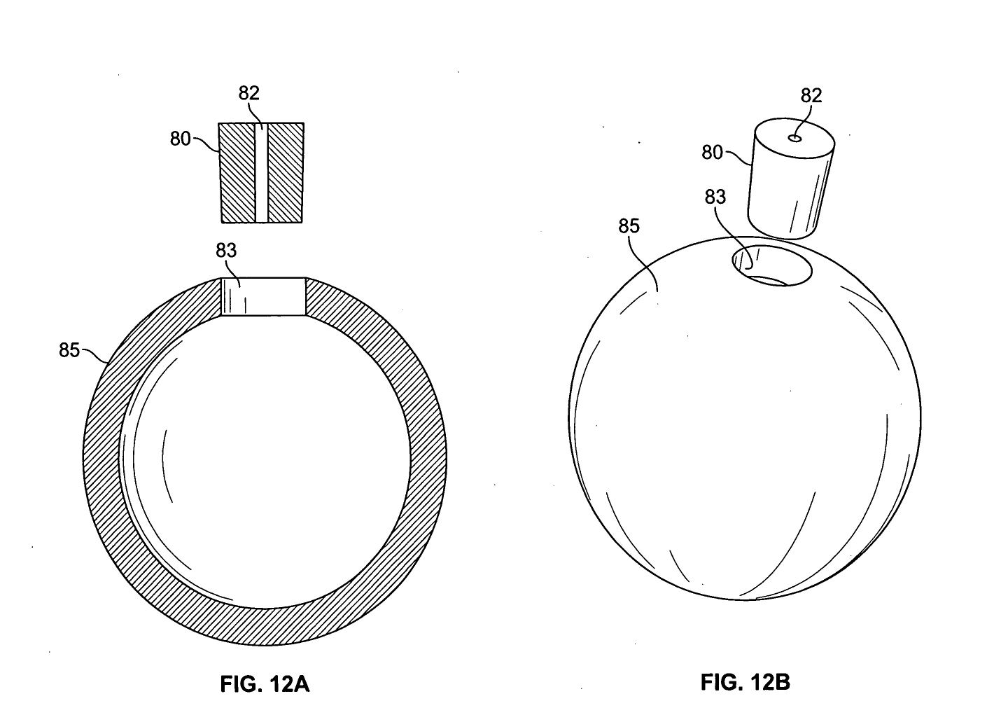

All or any of the above embodiments may include a squeaker of conventional construction to form a noise when the pet toy is squeezed. FIGS. 12(a) and 12(b) show how a conventional squeaker 80 having an air passageway 82 is inserted in a hole 83 formed in a hollow rubber core body 85 after it is molded following the procedure in connection with FIGS. 1(a), 1(b), 2(a) and 2(b) respectively. The squeaker 80 is permanently sealed within the hole 83 of the rubber core body 85 by applying glue to the hole 83 before inserting the squeaker 80. The squeaker 80 may be covered by the shaggy thick fleece fabric independent of the configuration of the pet toy. In this embodiment, the shaggy thick fleece fabric is sufficiently porous to permit air to flow through the thick fleece fabric in communication with the squeaker 80 without having to form a hole in the fabric.

What is claimed is:

1. A method for fabricating a toy having a shaggy thick fleece fabric outer coating and an inner body of an elastically deformable hollow rubber core comprising the steps of molding a rubber hollow core body from at least two rubber core sections for forming a molded hollow body of any desired geometry having a rubber seam between the core sections, adhesively attaching at least two pieces of thick fleece fabric to the rubber core body with each piece of fabric being of appropriate size such that the pieces of fabric cover the entire outer surface of the hollow rubber core body in a thickness of between about 8 mm to 20 mm and with each piece of fabric having cut edges forming the outline of a predetermine pattern which in combination conform to the desired shape of the pet toy, aligning the edges of the two or more pieces of fabric on the surface of the rubber core body to cover the entire outer surface of the rubber core body such that the aligned edges between adjacent pieces are in abutment relative to one another, and molding the rubber core body with the covered adhesively attached pieces of fabric at a sufficient pressure and temperature to form fabric seams at the mated edges having an orientation independent of the orientation of the rubber seam between the rubber core sections.

2. A method as claimed in claim 1 further comprising inserting a squeaker into the rubber core body before covering the body with said shaggy thick fleece fabric outer coating.

3. A method as claimed in claim 2 wherein a hole is formed in said body into which said squeaker is inserted.

4. A method as claimed in claim 1 in which the rubber hollow core body is molded from two half sections of a rubber core each having a semi-spherical geometry with each of the pieces of fabric patterned to form a spherical covering over the entire rubber core body to simulate a tennis ball.

5. A method as claimed in claim 2 in which the rubber hollow core body is molded from two half sections of a rubber core each having a semi-spherical geometry, with each of the pieces of fabric patterned to form a spherical covering over the entire rubber core body to simulate a tennis ball.

6. A method as claimed in claim 1 in which the rubber hollow core body is in a geometrical shape selected from the group comprising a bone, a dumbbell, a heart, a star and a donut shaped ring and wherein two pieces of fabric are adhesively applied to the rubber core body and patterned to outline the shape of the bone, dumbbell, heart, star and a donut, respectively.

7. A method as claimed in claim 1 in which the rubber hollow core body is in a geometrical shape selected from the group comprising a bone, a dumbbell, a heart, a star and a donut shaped ring and wherein three or more pieces of fabric are adhesively applied to the rubber core body and patterned to outline the shape of the bone, dumbbell, heart, star and a donut, respectively and wherein the three pieces form at least three fabric seams over the rubber hollow core body.

8. A method as claimed in claim 2 in which the rubber hollow core body is in a geometrical shape selected from the group comprising a bone, a dumbbell, a heart, a star and a donut shaped ring and wherein two pieces of fabric are adhesively applied to the rubber core body and patterned to outline the shape of the bone, dumbbell, heart, star and a donut, respectively.

9. A method as claimed in claim 2 in which the rubber hollow core body is in a geometrical shape selected from the group comprising a bone, a dumbbell, a heart, a star and a donut shaped ring and wherein three or more pieces of fabric are adhesively applied to the rubber core body and patterned to outline the shape of the bone, dumbbell, heart, star and a donut, respectively and wherein the three pieces form at least three fabric seams over the rubber hollow core body.

10. A method as claimed in claim 1 in which the rubber hollow core body is in the geometrical shape of a football and wherein four pieces of fabric are adhesively applied to the rubber core body with two on each side in a patterned outline of a football.

11. A method as claimed in claim 2 in which the rubber hollow core body is in the geometrical shape of a football and wherein four pieces of fabric are adhesively applied to the rubber core body with two on each side in a patterned outline of a football.

12. A pet toy comprising an inner elastically deformable hollow rubber core body of any desired shape, and a plurality of pieces of shaggy thick fleece fabric molded to the rubber core body with each piece of fabric substantially equal in size to one another and having a thickness between about 8 mm to 20 mm and with the plurality of pieces of fabric being adhesively fastened to the entire surface of the rubber core body such that their edges mate to one another in an arrangement forming fabric seams during molding at elevated temperature and pressure and with the pieces of fabric forming a pattern outlining the shape of the toy.

13. A pet toy as defined in claim 12 wherein said inner elastically deformable hollow rubber core body includes a squeaker.

14. A pet toy as defined in claim 12 wherein the hollow rubber core body is in a shape selected from the group comprising a ball, a bone, a dumbbell, a football, a star, a heart and a donut shaped ring.

15. A pet toy as defined in claim 13 wherein the hollow rubber core body is in a shape selected from the group comprising a ball, a bone, a dumbbell, a football, a star, a heart and a donut shaped ring.

16. A pet toy as defined in claim 14 wherein the treads of the sheep fleece fabric are of the same length to provide a uniform consistent thickness in a range of between 8 mm to 20 mm.

17. A pet toy as defined in claim 15 wherein the treads of the sheep fleece fabric are of the same length to provide a uniform consistent thickness in a range of between 8 mm to 20 mm.

18. A pet toy as defined in claim 14 wherein said covering includes at least three pieces of fabric forming more than one fabric seam in an orientation independent of the orientation of the rubber seam.

19. A pet toy as defined in claim 18 wherein the pieces of fabric form at least three fabric seams around the rubber core body.

20. A pet toy as defined in claim 17 wherein said covering includes more than one fabric seam in an orientation independent of the orientation of the rubber seam.

21. A pet toy as defined in claim 20 wherein the pieces of fabric form at least three fabric seams around the rubber core body.

22. A method for fabricating a toy having a shaggy thick fleece fabric outer coating and an inner body of an elastically deformable hollow rubber core comprising the steps of molding a rubber hollow core body of any desired geometry, forming a hole in the rubber hollow core body for receiving a squeaker, adhesively attaching at least two pieces of thick fleece fabric to the rubber core body with each piece of fabric being of appropriate size such that the pieces of fabric cover the entire outer surface of the hollow rubber core body in a thickness of between about 8 mm to 20 mm and with each piece of fabric having cut edges forming the outline of a predetermine pattern which in combination conform to the desired shape of the pet toy, aligning the edges of the two or more pieces of fabric on the surface of the rubber core body to cover the entire outer surface of the rubber core body such that the aligned edges between adjacent pieces are in abutment relative to one another, molding the rubber core body with the covered adhesively attached pieces of fabric at a sufficient pressure and temperature to form fabric seams at the mated edges, and adhesively inserting a squeaker into the hole formed in the rubber core body before adhesively attaching the fabric pieces to the rubber core such that the shaggy thick fleece forms an outer covering over the squeaker with the fabric having a porosity sufficient to permit air to flow therethrough in communication with the squeaker.
